(19) United States
(12) Patent Application Publication
(10) Pub. No.: US 2014/0377467 A1
(43) Pub. Date: Dec. 25, 2014

(54) TEXTILES HAVING ANTIMICROBIAL PROPERTIES AND METHODS FOR PRODUCING THE SAME

(71) Applicants: Brian R. George, Pottstown, PA (US); Katherine E. Bogash, Glenn Mills, PA (US)

(72) Inventors: Brian R. George, Pottstown, PA (US); Katherine E. Bogash, Glenn Mills, PA (US)

(73) Assignee: PHILADELPHIA UNIVERSITY, Philadelphia, PA (US)

(21) Appl. No.: 14/215,907

(22) Filed: Mar. 17, 2014

Related U.S. Application Data
(63) Continuation-in-part of application No. 12/705,843, filed on Feb. 15, 2010.
Application No. 12/705,843 is a continuation-in-part of application No. 13/052,592, filed on Mar. 21, 2011.
Application No. 13/052,592 is a continuation-in-part of application No. 13/112,252, filed on May 20, 2011.
(60) Provisional application No. 61/789,849, filed on Mar. 15, 2013.
(60) Provisional application No. 61/792,261, filed on Mar. 15, 2013.

(51) Int. Cl. A41D 31/00; D06B 3/04; A01N 31/16; A01N 25/34; A01N 35/02; D06B 3/18; A41D 13/12

(52) U.S. Cl. CPC A41D 31/0077; D06B 3/18; D06B 3/04; A41D 13/12; A01N 25/34; A01N 35/02; A01N 31/16
USPC 427/381

(57) ABSTRACT

A method for inhibiting the spread of nosocomial infections in institutional health care settings comprises treating outer garments, worn indoors by employed staff of the institution, to impart antimicrobial properties to those garments by immersing the garments in a solution of glyxol, eugenol and water, squeezing the solution out of the garments, curing the wetted garments under heat, and drying the cured garments; and thereafter requiring employed staff to wear the treated garments while working at the institution; laundering the garments after being worn by the staff, for further wear by the staff, and requiring employed staff to wear the treated garments after the garments have been laundered for so long as the garments retain their antimicrobial properties.

### CROSS-REFERENCE TO RELATED PATENT APPLICATION

This patent application claims the benefit of the priority under 35 USC 119 and 35 USC 120 of provisional U.S. patent application Ser. No. 61/789,849 filed 15 Mar. 2013 and entitled “Textiles Having Antimicrobial Properties and Methods for Producing the Same” and the priority of provisional U.S. patent application Ser. No. 61/792,261 filed 15 Mar. 2013 and entitled “Antimicrobial Textiles and Methods for Production of the Same”.

This patent application is a 35 USC 120 continuation-in-part of pending United States utility patent application Ser. No. 12/705,843 entitled “Methods and Apparatus for Combating Sick Building Syndrome”, filed 15 Feb. 2010, and a 35 USC 120 continuation-in-part of pending U.S. utility patent application Ser. No. 13/052,592, entitled “Methods for Imparting Anti-Microbial, Microbiocidal Properties to Fabrics, Yarns and Filaments, and Fabrics, Yarns and Filaments Embodying Such Properties”, filed 21 Mar. 2011, and a 35 USC 120 continuation-in-part of pending U.S. utility patent application Ser. No. 13/112,252, entitled “Methods and Apparatus for Passive Reduction of Nosocomial Infections in Clinical Settings, and Fabrics, Yarns, and Filaments for use in Connection Therewith”, filed 20 May 2011.

### INCORPORATION BY REFERENCE

This patent application incorporates by reference the disclosures of U.S. patent application Ser. No. 12/705,843 filed 15 Feb. 2010 and published as US 2011/020126 A1 on 18 Aug. 2011; U.S. patent application Ser. No. 13/052,592 filed 21 Mar. 2011 and published as US 2011/0229542 A1 on 22 Sep. 2011; and U.S. patent application Ser. No. 13/112,252 filed 20 May 2011 and published as US 2011/0236448 A1 on 29 Sep. 2011.

### BACKGROUND OF THE INVENTION AND DESCRIPTION OF THE PRIOR ART

The number of functional textiles with antimicrobial activity has increased considerably over the past decade. Consumers are now increasingly aware of a hygienic lifestyle and there is a necessity and expectation for a wide range of textile products with antimicrobial properties especially in the healthcare environment where nosocomial, or healthcare acquired infections, are a growing problem. Healthcare acquired infections are infections that patients acquire during the course of receiving healthcare treatment for other conditions. Despite increased surveillance, awareness, and attention to hospital cleanliness, about thirteen percent of high-risk adult patients develop nosocomial infections each year. Textile materials may be responsible for disease transmission and the spread of new strains of diseases from the main sources to elsewhere. However, textile materials, as necessary materials for clothing and daily life, are possible means for prevention of infectious diseases and pathogens if they have antimicrobial properties. By treating the textiles with an antimicrobial finish, cross contamination during use can diminish considerably.

Antimicrobial agents are natural or synthetic compounds that inhibit the growth of microorganisms or kill the microorganisms. Many commercial products are currently available on the market with a range of antimicrobial properties for the textile industry. A majority of such products are synthetic based and have a reduced spectrum of microbial inhibition and may cause skin irritation, as well as eco-toxicity. Moreover, the biocide can gradually lose activity during the use and launderings of the textile product. In addition, wearing these textiles in a continuous manner can lead to human sensitization and bacteria resistance. As a result and to minimize such risks, there is a great demand for durable antimicrobial textiles based on nontoxic and eco-friendly agents.

Despite increased surveillance, awareness, and attention to cleanliness, about thirteen percent of high-risk adult hospital patients develop nosocomial infections each year. Approximately one out of every twenty hospitalized patients will contract a healthcare acquired infection. In the United States alone, nearly two million patients annually contract an infection while being treated for another illness or injury. The infections related to medical care can be devastating and even deadly, with healthcare acquired infections ranking fourth among causes of death in the United States. The most common pathogens responsible for healthcare acquired infections include Staphylococci (especially Staphylococcus aureus), Pseudomonas, and Escherichia coli. In a 2001 survey of eighty seven New Jersey hospitals three strains of resistant bacteria were identified as being the most dangerous; methicillin-resistant Staphylococcus aureus (MRSA), vancomycin-resistant enterococci (VRE), and gram negative enteric bacilli including Klebsiella pneumonia, E. coli, and Enterococci. Another multi-resistant bacterium, Clostridium difficile, has become a recent issue in hospital environments.

Much of the spread of these bacteria remains via the passive transfer involving the scrubs, gowns, and white coats of hospital personnel as bacteria can be transferred from contaminated textiles to skin in under two minutes. MRSA was found not only existing, but also surviving for long periods of time, on all of the textile materials in a hospital environment. A recent survey from Virginia Commonwealth University on attitudes towards white coat cleanliness found that over ninety percent of respondents reported wearing white coats daily on most days of the week, and sixty two percent said that they waited two weeks or longer to launder them. Nevertheless, laundering is an ineffective preventative measure. Within eight hours, a freshly laundered white coat is as contaminated as one that is infrequently laundered.

Textile materials may be responsible for disease transmission and the spread of new strains of diseases from the main sources to elsewhere. However, textile materials, as necessary materials for clothing and daily life, are possible means for prevention of infectious diseases and pathogens if they are antimicrobial. By treating the textiles with an antimicrobial finish, cross contamination during use can diminish considerably. The transfer of microbes to hospital personnel garments that are treated with an antimicrobial finish will result in the microbe's inability to replicate and/or death thus eliminating their widespread transfer. However, the antimicrobial agent must not introduce more problems than it prevents, such as microbial adaptation to leaching microbial poisons employed with conventional antimicrobial chemicals. Furthermore the treatment must be effectively permanent and should not cause problems such as irritation for the wearer. Controlling and/or killing the microorganisms commonly associated with infections is a key component in maintaining an aseptic surface. The effective use of antimicrobial fabrics in a hospital setting will significantly reduce the indirect contact dissemination of bacteria and other microorganisms in hospital environments, thus reducing the rate of nosocomial infections.

Mold, mildew, fungus, yeast, bacteria, and virus (microorganisms), are a part of everyday life. There are both beneficial and detrimental microorganisms. Thousands of species of microorganisms are found everywhere in the environment, on garments, and on the human body. Harmful microorganisms are human irritants, sensitizers, toxic response agents, and carriers of disease.

Microorganisms need moisture, nutrients, proper temperature, and most of them need to be associated with a surface. Moisture can come from the human body, condensation on surfaces, and/or humidity in the air. Nutrients utilized by microorganisms can be organic material, such as proteins and carbohydrates, inorganic material, for instance, hydrogen, and/or living tissue. Given acceptable growth conditions, microorganisms can multiply from a single organism to more than one billion in just eighteen hours.

Bacteria, a type of microbe, can have a major impact on human life. Bacteria can be identified as either gram positive or gram negative, which can be distinguished by the content and structure of their cell wall through a staining procedure called gram stain. Gram negative bacteria have an additional layer of outer membranes. With the protection provided by the extra cell wall, gram negative bacteria are usually more persistent in survival and more difficult to inhibit growth than gram positive bacteria. An example of gram negative bacteria is K. pneumoniae, which is the major cause of urinary tract infections, septicemia, and pneumoniae in people with compromised immune systems. Another example of gram negative bacteria is Escherichia coli (E. coli) which can cause severe diarrhea as well as severe anemia or kidney failure, leading to death. One example of gram positive bacteria is Staphylococcus aureus, one of the major causes of hospital acquired infections. S. aureus can cause boils, skin infections, pneumonia, and meningitis, especially in debilitated persons.

### SUMMARY OF THE INVENTION

In recent years there has been an increase in the range of antibacterial textile based products available especially in hygiene-sensitive sectors such as the healthcare sector. The term “antimicrobial” refers to a broad range of technologies that provide varying degrees of protection for products and buildings against microorganisms. Antimicrobials differ in their chemical nature, mode of action, impact on people and the environment, durability on various substrates, and how they interact with beneficial and harmful microorganisms.

Antimicrobial textiles can be categorized into two groups, biocidal and biostatic materials, according to their functions. Biostatic functions refer to inhibiting growth of microorganisms on textiles and preventing the materials from biodegradation. Biocidal materials are able to kill microorganisms, thus eliminating their growth, sterilizing the textile, and possibly protecting the wearer from biological attacks. The desired performance of an antimicrobial treated surface is to significantly reduce levels of microbial contamination when compared to a similar untreated surface.

There are thousands of chemistries on the earth that kill microorganisms. Many of these, like arsenic, lead, tin, mercury, silver, plant extracts, and animal extracts are “natural”, but can also be highly toxic to people and the environment. An effective antimicrobial for the textile industry cannot just kill or repel microorganisms; it must do so safely, over the life of the treated product, and without negatively affecting the other important characteristics of the textile. It is critical to review all uses of chemicals used in antimicrobial textiles in light of the intended use and the toxicological profile of the chemical. This is especially relevant as one remembers that antimicrobials, by definition and function, inhibit and/or kill living things.

Primary considerations when selecting an antimicrobial textile material should be the possession of a number of important characteristics. The antimicrobial textile should facilitate the rapid inactivation of a broad spectrum of microorganisms, the antimicrobial agent should have selective activity to undesirable microorganisms, and the antimicrobial agent should not allow for the development of microorganisms which are resistant to the active component. The antimicrobial chemistry should be safe for the manufacturer and user; it should be non-toxic and should not cause skin irritation or sensitization, as well as being safe for the environment. Lastly, the antimicrobial should not negatively affect the textile product appearance or properties and must be durable through repeated laundering, that is to say the efficacy of the antimicrobial treatment should not diminish due to repeated wash and dry cycles.

Antimicrobial properties of textile materials can be obtained by two approaches: chemically or physically incorporating antimicrobial agents into fibers, yarns, or fabrics. Antimicrobial agents can either be incorporated within the fiber structure, which is a viable option for synthetic fibers as an inherent treatment in which the antimicrobial agent is added to the fiber during the spinning process, or the agent can be applied to the surface of fibers, yarns, or fabrics as a finish or coating after the substrate has been produced. Both techniques are currently used depending upon the type of product and its intended application.

Addition to the polymer melt is fraught with problems that must be evaluated if this application method is being considered. The performance challenge presented by creating a toxicant reservoir inside a fiber when the contact with the microbe will be on the surface is dependent on the solubility constant of the antimicrobial, the way it is embedded into the polymer matrix, the ability of the chemical to move in the polymer matrix, and the nature of the environment around the fiber during use. Other challenges revolve around the need for uniform mixing and subsequent dose release of the antimicrobial, changes in fiber properties, negative effects on color or reflectance, and problems associated with processing. After a polymer is extruded into the fiber form, antimicrobials can be added via drawing oils or spin finishes.

This method has merit if the issues of compatibility and uniformity can be solved and properties of the spin finish are maintained. The fiber treatment must also be able to survive all of the downstream processing without interfering with further processing or presenting any hazards to the workers, process equipment, or the environment. The antimicrobial treatment may also be added in one of the post drawing processing points or to the yarn or fabric. The addition of the antimicrobial to the final substrate can be done with spraying technology or with a pad bath.

Antimicrobials do not all work the same. The vast majority of antimicrobials work by leaching or moving from the surface from which they are applied to the environment to create a field of activity. Besides the challenges of providing durability for the useful life of products, leaching technologies have the potential to cause a variety of other problems. These leaching properties can contact the skin and potentially affect normal skin bacteria, cross the skin barrier, and/or have the potential to cause rashes and other skin irritations. A more serious problem with leaching technologies is that they allow for the adaptation of microorganisms. The conventional leaching antimicrobials leave the textile and chemically enter or react with the microorganism as a poison. Leaching antimicrobials are often effective, but are used up in the process of working, wasted in random misses, or complexed by other chemicals in the environment of use. Leaching technologies have been incorporated into fibers to slow the release rate and extend the useful life of the antimicrobial, and chemical binders have also been added with the claim that they are now “bound”. But whether leaching antimicrobials are extruded into the fiber, placed in a binder, or simply added as a finish to fabrics or finished goods, they all function the same. In all cases leaching antimicrobial technologies provide a killing field or “zone of inhibition”.

The zone of inhibition is the area around the treated substrate into which the antimicrobial chemistry leaches or moves to, killing or inhibiting microorganisms. This zone exists in real-world uses if it is assumed that the right conditions are present for leaching of a lethal dose at the time that it is needed. The killing or inhibiting action of a leaching antimicrobial is witnessed when AATCC 147 Antibacterial Activity Assessment of Textile Materials: Parallel Streak Method test or other zone of inhibition tests are run. These tests are used to measure the zone of inhibition created by a leaching antimicrobial and clearly define the area where the antimicrobial has come off the substrate and killed or inhibited the microorganisms in the agar. As with any chemistry that migrates from the surface, a leaching antimicrobial is strongest in the reservoirs, or at the source, and weakens the farther it travels from the reservoir. The outermost edge of the zone of inhibition is where the sub-lethal dose can be found, this is known as the zone of adaptation. This is where the resistant microbes that have been produced by leaching antimicrobials are found.

Microbes are living organisms and like any living organism will take extreme measures to survive. Microorganisms can be genetically mutated or enzymatically induced into tougher “super-strains” if they are exposed to sub-lethal doses of antimicrobial agents. The exposure of the microbe to a sub-lethal dose of an antimicrobial can cause mutation of their genetic materials, allowing for resistance that is then replicated through the reproductive process creating generations of microorganisms that are no longer affected by the chemistry. This phenomenon is of serious concern to the medical community and should be a serious consideration in the choosing of antimicrobial technologies. The ongoing challenge for leaching technologies is the control of the leach rate from the reservoir such that a lethal dose is available at the time that it is needed.

Significantly different, and a much more unique antimicrobial technology is used and does not leach, but instead remains affixed to the surface on which it is applied. This technology is referred to as a “barrier block” mechanism. The bound antimicrobial technology remains affixed to the substrate killing microorganisms as they come into contact with the surface to which it is applied. Once polymerized or chemically bonded, the treatment does not migrate or create a zone of inhibition so it does not set up conditions that allow for the adaptation of microorganisms. Because this technology stays on the substrate, it does not cross the skin barrier and neither affects normal skin bacteria nor causes rashes or skin irritations. Another benefit of the bound antimicrobial technology is that effective levels of this technology do not leach or diminish over time.

The durability of antimicrobial functions of textile materials can be grouped into two categories: temporary and durable functions. Temporary antimicrobial properties of fabrics are easy to achieve in finishing, but readily lost in laundering and thus are useful only for disposable materials or fabrics that will not be laundered. Durable antimicrobial functions have been achieved by using a common technology, a slow-releasing method on certain textiles, mainly for preservation of the materials from biodegradation or for odor reduction. According to this method, sufficient antimicrobial agent should be incorporated into fibers or fabrics in a wet-finishing process to provide prolonged usage. The fabrics inactivate bacteria by slowly releasing the agents from the surface of the materials. However, the antimicrobials eventually vanish completely since they are impregnated in materials without covalent bonding.

There are various methods available for improving the durability of antimicrobial finishes. One method is treating the fiber with resin, condensate, or crosslinking agents. Resin or crosslinking agents in finishes usually consist of urea formaldehyde, melamine formaldehyde, or other resins. Another method is the microencapsulation of the antimicrobial agents within the fiber matrices. Microencapsulation is a physiochemical technique in which a substrate reservoir contains an antibacterial agent that is held between two layers of polymer so that the active agents migrate to the outer layer as needed. Fabrics that are treated with microencapsulated antimicrobial agents are reported to be durable up to several wash cycles. The prolonged bioactivity of the fabric is due to the slow diffusion of the microbial agent out of the polymer reservoir.

A different approach, one more commonly used, is the insolubalization of the active substance in or on the fabric. A variety of chemical compounds have been used in this approach such as organosilicon and phosphorus compounds, zinc salt chelated with ethylene diamine tetra acetic acid (EDTA), and nitrofurane compounds. Another option to impart durability to the antimicrobial textile is the chemical modification of the fiber by covalent bond formation and the use of graft polymers, homopolymers, and/or co-polymerization on the fiber. The modification of the cellulose macromolecule by attaching the antimicrobial group to the polymeric chains renders cotton and cotton blend textiles antimicrobial.

There are qualitative (AATCC 147 Antibacterial Activity Assessment of Textile Materials: Parallel Streak Method) and quantitative (AATCC 100 Antibacterial Finishes on Textile Materials: Assessment of) test methods to determine the antimicrobial properties of treated textiles. The qualitative methods are easy, fast, and useful when a large number of samples need to be screened. AATCC Test Method 147 is a qualitative method termed a “halo” assay. This method involves a test specimen and an untreated control sample which are placed into contact with nutrient agar plates containing the bacterial cells of either gram positive of gram negative bacteria. The qualitative method evaluates the bacterial activity by the halo formation (absence of bacteria growth around the edges of the test specimen). After a twenty-four hour incubation period at thirty-seven degrees centigrade, a clear zone of “no growth” is indicative of antimicrobial activity. There is also a formula to measure the zone of inhibition even though it cannot be considered as a quantitative indication of the antibacterial activity because the colonies are not counted.

AATCC Test Method 100 is a quantitative method that provides values of antimicrobial activity based on the reduction of microorganism population, e.g. based on the number of bacteria still living after incubation with the bioactive specimen. In accordance with AATCC Test Method 100, control and test swatches are inoculated with the test organism. After incubation the bacteria levels on both the control and test fabrics are determined by elution in neutralizing broth, followed by dilution and plating, applying a thin layer of the samples on a nutrient agar plate. The number of bacteria present in this liquid is determined and the percentage reduction by the treated material is calculated with the following formula: 100(B−A)/B=R where R is the percent reduction of bacteria by the specimen treatments, A is the number of bacteria recovered from the microbial suspension at the end of the experiment after the twenty four hour incubation period, and B is the number of bacteria recovered from the microbial suspension at the beginning of the experiment. Quantitative methods are more time consuming and require a greater number of test specimens.

One of the most durable types of antimicrobial products is based on a diphenylether (biphenyl) derivative known as either 2,4,4′-trichloro-2′ hydroxyl biphenyl ether or 5-chloro-2(2,4-dichloro phenoxyl) phenol, commonly referred to as Triclosan. Triclosan products have been used for more than twenty five years in hospital and personal care products such as antimicrobial soap, toothpaste, and deodorants. Triclosan inhibits the growth of microorganisms by using an electrochemical mode of action to penetrate and disrupt cell walls. When the cell walls are penetrated leakage of metabolic enzymes occurs and other cell functions are disabled thereby preventing the organism from functioning or reproducing. Triclosan, when incorporated within a polymer, migrates to the surface where it is bound. Because it is not water soluble it does not leach out and it continuously inhibits the growth of bacteria in contact with the surface using barrier or blocking action. However, Triclosan has been found to cause mutations of drug-resistant strains in microorganisms, which is a major concern. Studies have found that many hospital acquired infections are naturally resistant to Triclosan, including P. aeruginosa, C. difficile, and Mycobacterium tuberculosis, and still more worrisome is that at sub-lethal concentrations bacteria becomes rapidly resistant to Triclosan.

Textiles can be made antimicrobial by harnessing the disinfecting power of oxidative chlorine, thus avoiding the limitations caused by the use of free chlorine. Chlorine bleach is a registered biocide and has been used as a disinfectant for decades without any reported resistance generated from any microorganisms. Unfortunately it is quite corrosive and toxic; particularly of concern is its ability to produce carcinogens (such as chloroform) in water. However, some chlorine derivatives, for example, halamine compounds, though possessing biocidal properties similar to chlorine, are more environmentally friendly and thus are widely used. Halamines inactivate microorganisms by oxidation mechanisms rather than biological functions, and wide usage of them could result in less concern about drug-resistance of microorganisms. Oxidizing agents can rapidly inactivate microorganisms by causing physiological damage to the cell membranes and/or disrupting metabolism, but this action is nonselective and nonmutable to all microorganisms. According to the mechanism of the biocidal function and regeneration process, diluted chlorine bleach solutions serve as activation and regeneration agents of the biocidal function of the textile. By using the chlorine bleaching process the potential biocidal groups grafted on cellulose, for example amide or imide nitrogen-hydrogen bonds in hydantoin rings, can be converted to biocidal halamine structures, allowing the textile materials to be sterilized. Halamines that can achieve this durable and regenerable antimicrobial function are chlorinated products of 5,5-dimethylhydantoin and 2,2,5,5-tetramethyl-4-imidazolidinone. Monomethylol (MDMH) or dimethylol derivatives (DMDMH) of 5,5-methylhydantoin and 2,2,5,5-tetramethyl-4-imidazolidinone can be employed in grafting the heterocyclic ring to cellulose. When a chlorine atom replaces hydrogen on the nitrogen-hydrogen moiety, the nitrogen-chlorine bond is formed, which is stabilized by the vicinal methyl or carbonyl groups on the grafted dimethylhydantoin ring. The stability of nitrogen-chlorine bonds on halamines contributes to the durability and stability of the antimicrobial properties on the fabrics.

It is known that treated cotton and cotton/polyester blended fabrics with two percent and six percent solutions of DMDMH and subsequently bleach them in a diluted chlorine solution. The fabrics are then evaluated against S. aureus and E. coli. A two percent concentration of the DMDMH the fabrics exhibit superior properties owing to their rapid and effective inactivation of the microorganisms.

The antimicrobial properties were durable and regenerable by chlorine bleaching, however, the active chlorine in halamines can be affected by laundering detergents, and thus, after each laundry cycle it is recommended that the fabrics be bleached in a separate cycle to recharge the antimicrobial properties. Unfortunately problems occur with finishes employing a regeneration mechanism because they require chlorine bleaching to activate the antimicrobial properties after laundering and over time chlorine may degrade natural fibers such as cotton.

Quaternary ammonium salts, particularly those with long hydrocarbon chains, have been used as bacteriostatic agents for fibers. Quaternary ammonium salts damage bacterial cells by affecting permeable properties of microorganisms, which usually results in slow action, taking more than ten hours of contact time to exhibit the maximum performance. A commercially available antimicrobial known as AEGIS employs the use of quaternary ammonium compounds. AEGIS Microbe Shield (AMS) is known as 3-trimethoxysilyl propyldimethyloctadecyl ammonium chloride, which is a combination of quaternary ammonium salt (QAS) and alkoxysilane. AMS is a bound antimicrobial technology. The substrate is coated with the cationic species one molecule deep. This is an ion exchange process by which the cation of the silane quaternary ammonium compound replaces protons from water or chemicals on the textile surface during treatment. Unique to materials such as silane quaternary ammonium compounds, the silanol allows for covalent bonding to receptive surfaces to occur. This bonding to the substrate is then made even more durable by the silanol functionality, which enables homopolymerization. The antimicrobial technology, on a molecular level, physically stabs the lipoprotein components of the membrane and electrocutes the anionic biochemicals in the membrane of the microorganism on contact to disable it. Quaternary ammonium compounds have limited effectiveness and, although once polymerized the quaternary ammonium compounds do not migrate, they still have the potential to cause skin irritation.

Polyhexamethylene biguanide (PHMB) is a commercially available antimicrobial technology that employs the use of the “barrier block” mechanism. PHMB is a polymeric antimicrobial agent. It is a polymer with an average of twelve biguanide groups per molecule. Several of the biguanide groups are involved in binding the agent to the fabric surface, and the other biguanide groups are involved in the disabling of the bacteria. PHMB is highly water soluble and most conventional means, such as padding and exhaustion from aqueous solution, are suitable application methods. An electrostatic attraction occurs between the positively charged PHMB and the negatively charged bacterial cell surface. For its antimicrobial effect, the PHMB displaces divalent cations in a bacterium essential to the integrity of the bacterial cell outer membrane. PHMB has broad spectrum antimicrobial activity against gram positive and gram negative bacteria as well as fungi and yeasts. PHMB as a concentrate is highly toxic to aquatic invertebrates, fish, and aquatic plants. It is also can produce severe eye irritation as well as skin sensitization in humans.

Table 1 provides a brief summary of the common synthetic antimicrobial agents and some properties. As can be seen, these materials are all fairly toxic and have undesirable side effects. Possible bacterial resistance may result in these antimicrobial agents becoming less effective in the future, as microbes adapt to these biocides, thus rendering them less effective.

There are a wide variety of natural antimicrobial agents available. Some of these are metallic elements, while others are plant derived. Many of these have been utilized as biocides for years due to their antimicrobial properties. However, the use of these agents in textiles is often relatively new.

The biocidal properties of silver compounds have been known for thousands of years and have been increasingly used recently to impart antibacterial properties to textile materials. Silver acts as a heavy metal by impairing the bacterial electron transport system as well as some DNA functions. Unlike other antimicrobials used in hospital environments, the prolonged use of silver has not been related to the appearance of resistant bacteria, in spite of being extensively used. Silver and nanosilver containing antimicrobial agents, for instance sodium silver sulphadiazine (SSD), are widely used in both hospital textiles and wound dressings because silver is generally recognized as a safe and broad spectrum antimicrobial agent. However, heavy metals have long been rejected where they come into contact with the environment or human skin. Silver in wastewater is extremely toxic to aquatic plants and animals. Repeated exposure of animals to silver may produce anemia, cardiac enlargement, degenerative changes in the liver, and growth retardation. Human skin contact with silver compounds has been found to cause allergic reactions such as rashes, swelling, and inflammation in some people.

Copper ions have been used for centuries to disinfect fluids, solids, and tissues. During the last two centuries, anecdotal evidence has been amply supported by scientific research to show that copper has antimicrobial properties, that it is capable of preventing the growth of dangerous pathogens such as bacteria, molds, algae, fungi, and viruses. Today copper is used as a water purifier, algaecide, fungicide, nematocide, molluscicide, as an antibacterial agent, and as an antifouling agent. It is considered safe for humans with a very low risk of adverse skin reactions. In contrast to the low sensitivity of human tissue (skin or other) to copper, microorganisms are extremely susceptible to copper. For example, it has recently been shown that copper surfaces reduce survival of epidemic methicillin-resistant S. aureus in healthcare environments. Copper toxicity to microorganisms, including toxicity to viruses, may occur through the displacement of essential metals from their native binding sites, from interference with oxidative phosphorylation and osmotic balance, and from alterations in the conformational structure of nucleic acids, membranes, and proteins. Exposure of gram positive and/or gram negative bacteria to fabrics containing copper oxide particles results in a potent reduction in the bacteria's viable titres, the concentration of thriving organisms.

Copper oxide can be impregnated into polymeric fibers or plated onto cotton fibers. Borkow, et al. have reported that impregnation or coating of cotton and polyester fibers with cationic copper endows them with potent broad spectrum antibacterial, antiviral, antifungal, and antimite properties. The biocidal properties of fabrics containing three to ten percent copper impregnated fibers are permanent, are not affected by washing conditions, and do not interfere with the manipulation of the final product such as dyeing or adding permanent press finishes.

Microencapsulated copper oxide nanoparticles as an antimicrobial agent for textile materials have excellent properties such as exceptional mechanical strength, antistatic, antibacterial, and UV absorption properties. A study has confirmed that the application of microencapsulated copper oxide nanoparticles to cotton fabric imparted the functional property of antibacterial resistance with a high percentage of reduction in bacteria at 99.99 percent and 92.71 percent respectively, for the two test organisms used; S. aureus and E. coli. However, the rate of antimicrobial activity showed a marginal fall of 3.47 percent and 7.99 percent after five washes and ten washes, respectively, against S. aureus, and 3.59 percent and 6.71 percent after five and ten washes, respectively, against E. coli. The study also revealed that the mechanical properties of the fabric were reduced slightly, but not enough to diminish the overall performance of the fabric.

Chitosan (poly(1-4)2 amino 2-deoxy β-D glucan), a deacetylated derivative of chitin is a natural, nontoxic, microbial resistant, and biodegradable polymer. Chitin is one of the most abundant polysaccharides found in nature, derived from marine shells and mollusks. Antifungal and antimicrobial properties of chitosan are believed to originate from the polycationic nature of chitosan that can bond with anionic sites in proteins thus resulting in selective antimicrobial activity towards fungi or bacteria. The antimicrobial activity of chitosan is influenced by a number of factors that include the type of chitosan, the degree of deacetylation, molecular weight, and other physiochemical properties. The antimicrobial activity of chitosan is also sensitive to pH, with higher activity at lower values. Chitosan can be attached chemically onto cotton fabrics by using crosslinking agents like glutaric dialdehyde and polycarboxylic acids. It can also be applied by padding cotton fabrics with a mixture of chitosan and citric acid followed by high temperature curing to impart durable antimicrobial properties. Chitosan has proven to be an effective antimicrobial agent against P. vulgaris, S. aureus, and E. coli, however there are limitations. Chitosan is only effective as an antimicrobial agent at higher concentrations and it has the potential to form a film on the surface of the fabric to which it is applied which decreases the air permeability and increases the stiffness after the application.

Silver containing chitosan fibers may be created by blending silver containing AlphaSan RC5000 particles in the spinning dope of chitosan fibers. Chitosan fibers containing silver are more effective than the original chitosan fiber in arresting bacteria growth. The silver containing chitosan fibers are more than 97 percent effective in reducing the bacteria count of Candida albicans, S. aureus, and Pseudomonas pyocyanea. The reduction in the bacteria count for the chitosan fiber against Candida albicans was 78.6 percent while for the silver containing chitosan fibers the reduction was 97.2 percent, clearly demonstrating that the silver containing chitosan fiber is more effective in controlling bacteria growth than the chitosan fiber alone.

Neem (Azadirachta indica) is an evergreen tree of India. It has been recognized as one of the most promising sources of compounds with insect control, antimicrobial, and medicinal properties. In India neem has been used since ancient times as a traditional medicine against various human ailments. The active ingredients of neem are found in all parts of the tree but in general, the seed, bark, leaves, and roots are the most used for extraction purpose. The active ingredients of neem extract are also used to inhibit the growth of gram positive and gram negative bacteria. Neem oil contains terpenoids, steroids, alkaloids, flavonoids, and glucosides, all which contribute to the antimicrobial activity of neem. Cotton fabric treated with neem seed extract at ten percent weight per volume along with crosslinking agents using the pad-dry-cure method after one wash the antimicrobial activity of the treated fabrics with various crosslinking agents showed excellent (more than 99 percent) antibacterial activity against S. aureus. After ten washes the most effective antimicrobial activity of the various cros slinking agents tested was only 40 percent. Neem has proven to be an effective antimicrobial agent however the fixation of this compound to fabric needs to be improved.

Silk sericin is a natural macromolecular protein derived from the silkworm Bombyx mori and constitutes 25-30 percent of the silk protein. It envelopes the fibroin fibers with successive sticky layers that help in the formation of the cocoon. Most of the sericin is removed during raw silk production at the time of reeling and other stages of silk processing and discharged in the processing effluent causing water pollution. Sericin is a biomolecule of great value as it has antibacterial, UV resistant, oxidative resistant and moisturizing properties (Joshi, et al.). Functional properties of some synthetic fibers can be improved by coating with silk sericin protein. Although sericin application on textiles for antibacterial property enhancement has not been reported yet, it does have the potential for such an application.

Many natural dyes obtained from various plants are known to have antimicrobial properties. It has been established that the presence of tannins is responsible for antimicrobial activity of most of these natural dyes. Tannins are naturally occurring polyphenols which are water soluble and found in many plant species as well as trees, in parts such as the bark, leaves, roots, or fruits, up to ten percent by dry weight. Tannins possess antimicrobial activity against a wide range of bacteria, and fungi. Tumeric or cumin, a yellow florescent pigment extracted from rhizomes of several species, has been used as a colorant for dyeing of wool, silk, and unmordanted cotton. Being a well-known antimicrobial agent since ancient times, turmeric imparts antimicrobial properties to textile materials.

Aloe vera (Aloe barbadensis) belongs to the family Liliaceae and is known as “Lily of the Desert”. Research has shown that aloe leaf contains a large number and variety of nutrients and active compounds. Aloe vera also has antibacterial and antifungal properties that can be exploited in applications in antimicrobial textiles. Although the aloe vera has some success inhibiting bacterial growth, aloe vera treatment with auxiliary chemicals achieves almost six times the inhibition due to the superior bonding of the aloe vera to the fabric. The most successful treatment appears to be aloe vera at 10 grams per liter, 10 grams per liter polyvinyl alcohol, and 100 grams per liter glyoxal.

Prickly chaff flower (Achysanthus aspera) is one of the herbs most commonly found in India. It presents antimicrobial activity against gram positive and gram negative bacteria but with low activity. Prickly chaff flower was tested on cotton fabrics but the results showed only mild antibacterial activity against gram negative bacteria.

Tulsi leaf extracts have proven to be an effective antimicrobial agent for finishing of cotton textiles. The active components in tulsi leaf extract are caryophyllene, phytol, and germacrene which belong to a category of terpenes that are reported to be antimicrobial compounds. Cotton fabrics have been treated with tulsi leaf extract in four different manners; direct application with one percent herbal extract and six percent citric acid as a cross linking agent, microencapsulation with the herbal extract as the core material and gum acacia as wall material, encapsulating the herbal extracts, with sodium sulphate and citric acid, cross linking the herbal extract with non-formaldehyde based resin and magnesium chloride as a catalyst, and a combination microencapsulation/crosslinking, combining those two methods into one treatment. Each of the treated fabrics showed good antimicrobial properties to gram positive bacteria S. aureus as well as gram negative bacteria Klebsiella pneumonia with a greater than 90 percent reduction for both microorganisms. Despite the good antimicrobial properties of the tulsi leaf treated fabrics, they had poor wash durability, the most severe being the direct treated fabrics which, after ten wash cycles no longer demonstrated any antimicrobial activity. The microencapsulated treated fabrics had less than 65 percent reduction of both microorganisms, and the microencapsulated/cross linked fabric fared a bit better with less than 72 percent bacterial reduction maintained after ten wash cycles. The most successful of the treatments, the cross linked fabrics, still lost activity after ten washes, maintaining less than 75 percent bacterial reduction.

Clove oil (eugenol) is the main product of Syzygium aromatium. Clove oil is currently used in mouth care products for tooth aches and as a breath freshener, as a filling or cement material such as zinc oxide eugenol for tooth repair, as rose oil in perfumes and soaps, and as an antioxidant for plastics and rubber as well as for sanitation purposes. Clove oil is a known antibacterial effective against S. aureus, pseudomonas aeruginosa, clostridium perfringens, and E. coli. It is also an effective antifungal agent against candida, aspergillus, penicillium, and trychophyton.

In the last few decades, with the increase in new antimicrobial fiber technologies and the growing awareness about cleaner surroundings and healthy lifestyles, a range of textile products based on synthetic antimicrobial agents such as Triclosan, metals and their salts, organometallics, phenols, and quaternary ammonium compounds have been developed and quite a few are available commercially. These synthetic antimicrobial agents are effective against a wide range of microbes, but they possess limitations in use such as associated side effects, action on non-target microorganisms, and water pollution. Therefore, there is still a great demand for antimicrobial textiles based on eco-friendly agents that not only help to effectively reduce the ill effects associated with microbial growth on textile materials, but also comply with the statutory requirements imposed by regulating agencies. There is a vast source of medicinal plants that possess active antimicrobial properties. Natural products such as chitosan, aloe vera, neem, clove oil, and others are all candidates for use as antimicrobial agents in treating fabrics. The relatively lower incidence of adverse reactions to both the environment and humans to herbal products compared to modern synthetic pharmaceuticals can be exploited as an attractive eco-friendly alternative to synthetic antimicrobial agents for textile application.

U.S. patent publication 2011/0236448 A1, of which this application is a continuation-in-part, discloses a method for imparting antimicrobial properties to textile materials to passively reduce nosocomial infections. The disclosed invention relates to fabrics treated to inhibit environmental isolates of gram positive and gram negative bacteria as well as spore-bearing microbes. The biocidal actives, in accordance with the '448 patent publication are successfully coupled to cotton, cotton/polyester blends, and rayon textiles. The naturally biocidal active ingredients that may be used in practicing the invention disclosed therein include: crushed cloves (2 percent mixed with water to create an aqueous solution), tumeric powder (2 percent of an aqueous solution), citric acid (5 percent of an aqueous solution), and corn gluten meal (5 percent of an aqueous solution).

The fabrics are immersed in the aqueous solutions for 30 minutes at room temperature and manually stirred at a constant rate. The fabrics are then rinsed in cold water and allowed to dry. Once dry the fabrics are then tested for their antimicrobial activity. In accordance with the '448 patent publication different methods of affixing the natural antimicrobials to the textiles may be used. For example, clove oil can be mixed with sodium bicarbonate or acetyl chloride and then applied to the textile material. In each case five percent of the solution was the natural ingredient. Combining the natural biocidal herbal ingredient with polyvinyl alcohol and glyoxal, drying the fabric (that has been soaked with the solution) at an elevated temperature, and then curing the sample at a greater temperature provides even better bonding of the biocidal treatment to the fabric. Fabric treatment of 100 percent cotton textiles using eugenol, aloe vera, and copper salt is within the scope of the '448 patent publication invention. The use of eugenol with polyvinyl alcohol and glyoxal is the preferred practice of the invention.

U.S. patent publication 2011/0236448 A1 discloses a method for treating cotton, rayon, and cotton/polyester fabric blends to impart biocidal properties thereto, comprising the steps of: a) preparing a solution of polyvinyl alcohol and glyoxal, b) adding eugenol to the solution, c) stifling the solution with the fabric therein for time sufficient for a biocidally active herbal of the eugenol to couple to the fabric, e) rinsing the fabric with water, and f) drying the fabric. A garment for wear by workers in clinical settings comprising fabric having a natural biocidally active herbal coupled thereto, selected from the group consisting of eugenol, cloves, tumeric powder, citric acid, corn gluten meal, and aloe vera, one aspect of the present invention is also within the scope of the '448 patent publication.

In one aspect of the present invention, cotton/polyester blend lab coats were treated in accordance with US patent publication 2011/0236448 A1, but with a modified formula.

### BRIEF DESCRIPTION OF THE TABLES AND DRAWING FIGURES

Table 1 is a Summary of Common Synthetic Antimicrobial Agents.

Table 8 presents the Difference in Performance as Between Samples Treated in Accordance with the Invention and Untreated Samples.

Table 9 presents t-Test data showing the Difference in Performance between Untreated Rinsed Samples and Treated, Rinsed Samples.

Table 10 presents t-Test data Showing the Difference in Performance between Five (5) Times Washed Untreated Rinsed Samples and Five (5) Times Washed Treated Rinsed Samples.

Table 11 presents t-Test data Showing the Difference in Performance between Ten (10) Times Washed Untreated Rinsed Samples and Ten (10) Times Washed Treated Rinsed Samples.

Table 12 presents Breaking Strength for Untreated Samples.

Table 13 presents Breaking Strength for Treated Samples.

Table 14 presents t-Test data for Untreated Rinsed and Treated Rinsed Samples.

Table 15 presents t-Test data for Five (5) Times Washed Untreated Rinsed and Five (5) Times Washed Treated Rinsed Samples.

Table 16 presents t-Test data for Ten (10) Times Washed Untreated Rinsed and Ten (10) Times Washed Treated Rinsed Samples.

Table 17 presents Qualitative Results of Inhibition of S aureus for Treated and Untreated, Rinsed and Unrinsed, and Washed and Unwashed Samples.

Table 19 presents Qualitative Results of Inhibition of B. cereus for Treated and Untreated, Rinsed and Unrinsed Samples.

Table 20 presents Quantitative Results of Inhibition of B. cereus for a Control and for Treated and Untreated, and for Rinsed and Unrinsed Samples.

Table 21 presents Quantitative Results of Inhibition of M. smegmatis for Treated and Untreated, and for Rinsed and Unrinsed Samples.

Table 22 presents Quantitative Results of Inhibition of M. smegmatis for a Control and for Treated and Untreated, and for Rinsed and Unrinsed Samples.

Table 24 presents Kawabata Evaluation System data at the Surface for “MIU”, “MMD” and “SMD” for Untreated Rinsed Samples and Treated, Rinsed Samples; Five (5) Times Washed Untreated Rinsed Samples and Five (5) Times Washed Treated Rinsed Samples; and Ten (10) Times Washed Untreated Rinsed Samples and Ten (10) Times Washed Treated Rinsed Samples.

FIG. 8 depicts the Difference in Tearing Strength Performance as Between Samples Treated in Accordance with the Invention and Untreated Samples

FIG. 9 depicts the Difference in Breaking Strength Performance as Between Samples Treated in Accordance with the Invention and Untreated Samples

FIG. 10 is a Graph of Tensile Strain at Maximum Loads for Untreated Rinsed Samples and Treated, Rinsed Samples; Five (5) Times Washed Untreated Rinsed Samples and Five (5) Times Washed Treated Rinsed Samples; and Ten (10) Times Washed Untreated Rinsed Samples and Ten (10) Times Washed Treated Rinsed Samples.

FIG. 11 is a photgraph of Five (5) Petrie dishes used in the Quantitative Evaluation of M. smegmatis.

FIG. 14 is a graph of the Quantitative Evaluation data for S. aureus colonies versus fabric treatment for a Untreated Rinsed Sample and a Treated, Rinsed Sample; a Five (5) Times Washed Untreated Rinsed Sample and a Five (5) Times Washed Treated Rinsed Sample; and a Ten (10) Times Washed Untreated Rinsed Sample and a Ten (10) Times Washed Treated Rinsed Sample.

FIG. 20 is a graph of the Quantitative Evaluation data for M. smegmatis colonies versus fabric treatment for a Untreated Rinsed Sample and a Treated, Rinsed Sample; a Five (5) Times Washed Untreated Rinsed Sample and a Five (5) Times Washed Treated Rinsed Sample; and a Ten (10) Times Washed Untreated Rinsed Sample and a Ten (10) Times Washed Treated Rinsed Sample.

FIG. 23 is a graph of Surface Evaluation “MIU” Values for Untreated Rinsed Samples and Treated, Rinsed Samples; Five (5) Times Washed Untreated Rinsed Samples and Five (5) Times Washed Treated Rinsed Samples; and Ten (10) Times Washed Untreated Rinsed Samples and Ten (10) Times Washed Treated Rinsed Samples.

FIG. 24 is a graph of Surface Evaluation “MMD” Values for Untreated Rinsed Samples and Treated, Rinsed Samples; Five (5) Times Washed Untreated Rinsed Samples and Five (5) Times Washed Treated Rinsed Samples; and Ten (10) Times Washed Untreated Rinsed Samples and Ten (10) Times Washed Treated Rinsed Samples.

FIG. 25 is a graph of Surface Evaluation “SMD” Values for Untreated Rinsed Samples and Treated, Rinsed Samples; Five (5) Times Washed Untreated Rinsed Samples and Five (5) Times Washed Treated Rinsed Samples; and Ten (10) Times Washed Untreated Rinsed Samples and Ten (10) Times Washed Treated Rinsed Samples.

FIG. 26 is a graph of Compression “LC” Values for Untreated Rinsed Samples and Treated, Rinsed Samples; Five (5) Times Washed Untreated Rinsed Samples and Five (5) Times Washed Treated Rinsed Samples; and Ten (10) Times Washed Untreated Rinsed Samples and Ten (10) Times Washed Treated Rinsed Samples.

FIG. 28 is a graph of Compression “RC” Values for Untreated Rinsed Samples and Treated, Rinsed Samples; Five (5) Times Washed Untreated Rinsed Samples and Five (5) Times Washed Treated Rinsed Samples; and Ten (10) Times Washed Untreated Rinsed Samples and Ten (10) Times Washed Treated Rinsed Samples.

FIG. 29 is a graph of Original Thickness for Untreated Rinsed Samples and Treated, Rinsed Samples; Five (5) Times Washed Untreated Rinsed Samples and Five (5) Times Washed Treated Rinsed Samples; and Ten (10) Times Washed Untreated Rinsed Samples and Ten (10) Times Washed Treated Rinsed Samples.

Note that the Table numbers and the Drawing Figure numbers are not consecutive.

### DETAILED DESCRIPTION OF THE INVENTION

The following are used in practicing various aspects of the present invention:

Lab Coats
META Labwear white lab coats distributed by White Swan brands
Fiber Content—65/35 polyester/cotton
Weave Style—Poplin
Fabric Weight—188.04 g/m², 482 grams per size XLarge lab coat
Ends per Centimeter—40
Picks per Centimeter—20

Chemicals
Naturally derived antimicrobial and associated fixative agents
Tap water
Tide Institutional Formula, Powder Soap

Test Microbes
Staphylococcus aureus—Clinical Isolate from skin
Bacillus cereus—Ward's Natural Science
Mycobacterium smegmatis—Ward's Natural Science

Antimicrobial Assessment Materials
Nutrient Broth—Ward's Natural Science
Agar—Ward's Natural Science
Petri Dishes—Ward's Natural Science
Eppendorf Tips—Ward's Natural Science
Puritan Sterile Cotton Tipped Applicators—Thomas Scientific

Equipment
Whirlpool Fabric Sense System Washing Machine type 111
Maytag Neptune Dryer model # MDE5500AYW
Industrial Laboratory Equip. Co., Inc. ILE/Sauter Scale model # RE2012
Instron 5543A CRE Breaking Strength Tester
Instron 5543A CRE Tearing Strength Tester
SDL International Martindale M235 Abrasion Resistance Tester
Pure Bending Tester—Kawabata's Evaluation System—2
Surface Tester—Kawabata's Evaluation System—4
Compression Tester—Kawabata's Evaluation System—3
Tensile & Shearing Tester—Kawabata's Evaluation System—1

In one aspect of this invention, cotton/polyester blend lab coats were treated largely in accordance with the teachings of U.S. patent publication 2011/0236448 A1 but using modified formulae. Specifically, the laboratory coats were treated with a modified formula respecting the aforementioned United States patent publication, with a modified solution of glyxol, eugenol, water and in most cases, polyvinyl alcohol. The coats were treated by immersing the coats in the solution, squeezing the solution out the coats, and curing the wetted coats under heating and drying. In the most preferable practice, the solution included 10 parts by volume of polyvinyl alcohol and 10 parts by volume of glyxol to 100 parts of water. The ratio of the amount of solution to the lab coats on a mass basis was 5 mass parts of solution to 1 mass part of lab coat. The amount of eugenol used can be as low as 1% by weight of the solution, but 10% by weight is the preferred amount of eugenol for use in the course of practice of this invention. Further details regarding kinds and appropriate amounts of the reagents and inclusion or exclusion of the same may be found in the United States patent publications incorporated by reference as set forth above.

All treated and untreated test specimens were conditioned at standard conditions of 27 degrees Celsius and 65 percent relative humidity for at least twenty-four hours prior to testing.

Samples that were tested included those that were untreated and rinsed; untreated, rinsed and laundered five times; untreated and rinsed with ten launderings; as well as treated and rinsed; treated, rinsed and laundered five times; and treated, rinsed with ten launderings.

Repeating and rinses, untreated and treated samples were rinsed separately as to not cross contaminate the untreated samples. The rinse cycle was carried out with a Whirlpool Fabric Sense System washing machine in a small load with cold water, normal agitation on the rinse cycle, and no detergent. The fabrics were then dried in the Maytag Neptune dryer on low heat for thirty minutes. All samples were kept separate to avoid possible contamination. The rinse cycle was performed to remove any unbonded chemicals from the antimicrobial finish process. For consistency among all test specimens, the untreated samples were also rinsed.

Repeating washing and drying, the untreated and treated samples were washed and dried separately to eliminate any possible cross contamination to the untreated samples. The washing was performed with a Whirlpool Fabric Sense System washing machine. The lab coats were washed in accordance with the care tag; warm water on the permanent press cycle and regular soil in a small load with one ounce of Tide Powder laundry detergent. The lab coats were then dried in the Maytag Neptune dryer as directed by the care label; tumble dry on medium heat for twenty minutes. This was done five consecutive times for the samples that are identified as rinsed and laundered five times, and ten consecutive times for the samples that are identified as rinsed and laundered ten times.

Weight was determined using the Standard Test Method for Mass per Unit Area (Weight) of Fabric—ASTM D 3776

Sample Size was 7.62 centimeters×7.62 centimeters (5 test specimens)

As respecting sample preparation, five test specimens were cut from each sample (untreated and rinsed; untreated, rinsed and laundered five times; untreated, rinsed with ten launderings; as well as treated and rinsed; treated, rinsed and laundered five times; and treated, rinsed and laundered ten times) including five samples cut from a lab coat prior to any treatment or rinsing (to determine the original weight of the lab coats).

Procedure—Test specimens were weighed individually on a Sauter Model RE2012 scale to determine mass in grams. The average of each sample of five test specimens was calculated and the weight was converted to g/m².

Breaking Strength—Standard Test Method for Breaking Strength and Elongation of Textile Fabrics (Grab Test) ASTM D5034

Sample Size—10 centimeters×15 centimeters (5 test specimens)

Sample Preparation—Five test specimens were cut from each sample with the 15 centimeter measurement parallel to the length of the lab coats.

Procedure—Test specimens were mounted individually in the jaws of the Instron 5543A CRE with the 15 centimeter length in the direction of the test (vertical). As per ASTM D5034 the loading rate was 300±10 millimeters per minute and the force was applied until the test specimen broke. Values for the breaking force and tensile strain of the test specimen were automatically processed by the computer interfaced with the testing machine and printed out in charts and graphs.

Tearing Strength—Standard Test Method for Tearing Strength of Fabrics by the Tongue (Single Rip) Procedure (Constant-Rate-of-Extension Tensile Testing Machine) ASTM D2261

Sample Size—7.5 centimeters×20 centimeters (5 test specimens)

Sample Preparation—Five test specimens were cut from each sample with the 7.5 centimeter measurement parallel to the length of the lab coats. A 7.5 centimeter long preliminary cut was then made at the center of the 7.5 centimeter width to form a “two-tongued (trouser shaped) specimen”.

Procedure—One tongue of the test specimen was gripped in the upper jaw of the Instron 5543A CRE machine and the other tongue was gripped in the lower jaw of the same machine “with the slit edge of each tongue centered in such a manner that the cut edges of the tongues form a straight line”. The top jaw moved at a rate of 50 millimeters per minute away from the lower jaw that remained stationary to propagate a tear. The average of the five highest peaks over a tearing distance of 76 millimeters was averaged and reported as the tearing force. The computer set up with the testing interface recorded the tearing force and produced a print out of the data.

Abrasion Resistance—Standard Test Method for Abrasion Resistance of Textile Fabrics (Martindale Abrasion Tester Method) ASTM D4966

Sample Size—5 centimeters×5 centimeters (4 test specimens)

Sample Preparation—Four test specimens were cut from each sample. A circular template with a diameter of 3.81 centimeters was used to cut the test specimens into the appropriate size and shape.

Procedure—The four test specimens were mounted on the Martindale Abrasion Tester in the four holders such that the face of the lab coat was abraded. Abrasion testing was run with the four test specimens from one sample (i.e. all four untreated rinsed samples were run first, next all four treated rinsed samples were run, etc.). Because the fabric had a mass less than 498.4 g/m² a 3.8 centimeter disk of polyurethane foam was placed between the test specimen and the metal insert. The standard abradent fabric, a plain weave worsted wool fabric was used as the abradent and was changed after each sample was tested (after ten thousand cycles). Ten thousand cycles were run removing one sample after every two thousand five hundred cycles (i.e. 2,500, 5,000, 7,500, and 10,000). This test method was used to visually evaluate the abrasion resistance of the untreated and treated fabrics.

Assessment of Fabric Mechanical Properties Relating to Hand—Kawabata Evaluation System (KES)

Sample Size—20 centimeters×20 centimeters (3 test specimens)

Sample Preparation—Three test specimens were cut from each sample.

Procedure—Pure Bending Test—The test specimen was mounted in the Pure Bending Tester, Kawabata Evaluation System—2, with the length of the lab coat, (for this research, considered the warp direction) parallel to the direction of the test. Once the test specimen was mounted the bending tester rotated counter-clockwise, then rotated clockwise through the starting point of the test, and finally rotated counter-clockwise to return to the original position, for a total bending assessment of 250 degrees. The computer set up with the testing interface was used to administer the test, as well as collect and evaluate the data. The procedure was then replicated to assess the specimens in a direction perpendicular to the length of the coat (for this research, considered the weft direction). Resistance to bending, or bending rigidity (B), as well as hysteresis, or recovery from bending (2HB) was measured.

Surface Test—Test specimens were mounted face up in the Surface Tester, Kawabata Evaluation System—4, with the warp parallel to the direction of the test. The measuring apparatus, that evaluates surface roughness, was lowered into place with ten grams of force applied to the test specimen. The detachable gauge, that evaluates friction, was mounted in place with a fifty gram weight to provide the appropriate force. The computer was used to run the test as well as gather and assess the data. The process was then replicated to evaluate the specimens in the weft direction. Coefficient of friction (MIU), mean deviation from the coefficient of friction (MMD), and surface roughness (SMD) were measured.

Compression Test—The test specimens were mounted face up in the Compression Tester, Kawabata Evaluation System—3. A maximum load of fifty grams per square centimeter was applied to the test specimen. Linearity of compression (LC), work of compression (WC), recovery from compression (RC), as well as original thickness (T0) and thickness under maximum compression (TM), was measured. The computer with the testing system was used to control the test as well as collect and analyze the data.

Shear Test—Test specimens were mounted in the Shear Tester, Kawabata Evaluation System—1, face up with the warp parallel to the direction of the test. A standard 200 gram weight was placed on the unsecured end of the fabric to ensure the specimen was mounted evenly. Once the specimen was properly mounted the fabric was sheared eight degrees to the right, the fabric then passed through the starting point to be sheared eight degrees to the left, and was finally returned to the original position. Shear stiffness (G) and hysteresis of shear (2HG and 2HG5) were measured. The computer with the testing interface ran the test and collected as well as evaluated the data. The procedure was then replicated to evaluate the specimens in the weft direction.

Tensile Test—The test specimens were mounted in the Tensile Tester, Kawabata Evaluation System—1, face up with the warp parallel to the direction of the test. A standard 200 gram weight was placed on the unsecured end of the fabric to ensure the specimen was mounted evenly. The screws were tightened with a wrench to guarantee that the fabric did not move during the test. Once the specimen was properly mounted the fabric was subjected to a load of 500 grams force per centimeter width. Linearity of the tensile load (LT), work of the tensile force (WT), tensile resilience (RT), and the extensibility (EMT) were measured. The data was collected and analyzed by the computer with the testing interface. The procedure was then replicated to assess the specimens in the weft direction.

Assessment of Antibacterial Finishes on Textile Materials—AATCC 147/AATCC 100

Sample Size—7.62 centimeters×7.62 centimeters (2-3 test specimens)

Sample Preparation—Three test specimens were cut from the treated samples as well as two test specimens from the treated lab coat prior to rinsing, and two test specimens from the untreated unrinsed sample to act as a control.

Test Organisms—Staphylococcus aureus, gram positive organism, Bacillus cereus, (an analog for anthrax) gram positive organism, and Mycobacterium smegmatis, (a model for tuberculosis) gram positive organism.

Procedure—AATCC 147—A pure culture of test microbe was applied to the entire surface of a clear nutrient agar plate which was then overlaid with small pieces of the test specimens. After a twenty-four hour incubation period at thirty-seven degrees Celsius, the test specimens were evaluated. A clear zone of “no growth” greater than or equal to three millimeters is considered indicative of antimicrobial activity. Fabrics that performed desirably for the qualitative method were then further analyzed quantitatively for their ability to reduce microbial growth.

AATCC 100—0.5 grams of the test specimens, cut into strips, were added to a microbial suspension of approximately 1×10⁵ colony forming units (CFU) per milliliter. As soon as possible after inoculation (“0” contact time), the first set of samples to be evaluated were plated. Serial dilutions were made for each test specimen and plated on clear nutrient agar plates. The remaining test specimens were left to incubate at thirty-seven degrees Celsius for twenty-four hours. After the twenty-four hour incubation time serial dilutions were made for each test specimen which were then plated on clear nutrient agar plates. Finally all plates were incubated for forty-eight hours at thirty-seven degrees Celsius. The percent reduction of bacteria was determined using the equation 100(B−A)/B=R where R is the percent reduction of bacteria by the specimen treatments, A is the number of bacteria recovered from the microbial suspension at the end of the experiment after the twenty-four hour incubation period, and B is the number of bacteria recovered from the microbial suspension at the beginning of the experiment.

There was slight variation in the mass per unit area of the samples that were tested. The variation was both within a set of test specimens as well as between the test specimens. The most notable difference was the mass per unit area of the untreated rinsed sample (189.4 g/m²) in comparison to the treated rinsed sample (184.9 g/m²), with a 2.36 percent difference, as depicted in tables three and four, as well as figure seven. A t-test was utilized to evaluate the significance of the differences between the samples as shown in tables five, six, and seven. The results of the tests showed that the differences between the untreated, and untreated, rinsed, with five launderings and their treated counterparts are significant. The variation within and between the samples can be accounted for by normal variation of the lab coats. Both the untreated and treated lab coats demonstrate a reduction in mass per unit area between the rinsed samples and the samples that were laundered ten times which can be attributed to the normal loss of fibers due to the laundering cycle. Overall it can be concluded that the antimicrobial treatment does not negatively impact the mass per unit area of the lab coats.

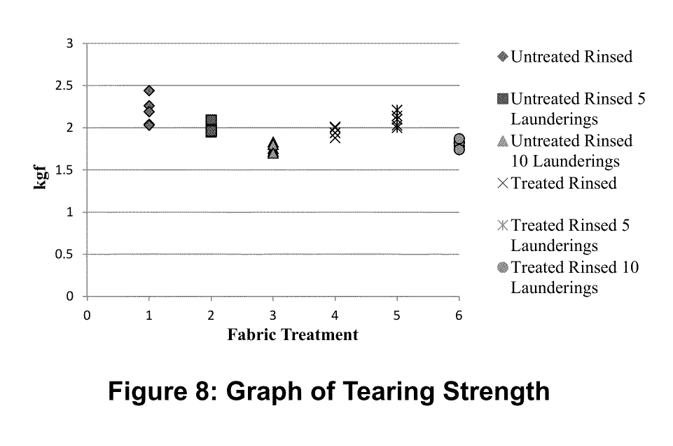

The difference between the untreated rinsed samples and the treated rinsed samples was 10.96 percent, with the untreated samples being the superior performer of the two as shown in Table 8 and FIG. 8. That disparity can be attributed to variation within the lab coats themselves rather than the treatment, because upon further consideration it is clear that the considerable difference is not a trend. The untreated samples with five and ten launderings exhibited lower tearing strength than their treated counterparts. There was approximately a five percent difference between the untreated and treated samples that had been laundered five times. There was a lower percent difference between the untreated and treated samples that had been laundered ten times, approximately three percent. There is a trend in the loss of tearing strength among washes. The untreated sample that had been rinsed and put through ten laundering cycles displayed roughly twenty percent less tearing strength than the untreated sample that had only been rinsed. Likewise, the treated sample that had been rinsed and laundered ten times had approximately seven percent lower resistance to tearing. Based on the data from the t-tests, as depicted in Tables 9, 10, and 11, the significant differences are between the untreated rinsed samples, and the untreated, rinsed, and laundered five times samples, and their treated counterparts. The tearing strength decreases over the course of laundering, due to the shrinking of the fabric which leads to the yarn's inability to shift to avoid the tearing force. Overall the treatment appears to have no adverse effect on the tearing strength of the lab coats, and it is possible that the treatment contributes to preventing further reduction in tear strength after multiple launderings, however further research would be needed to confirm this.

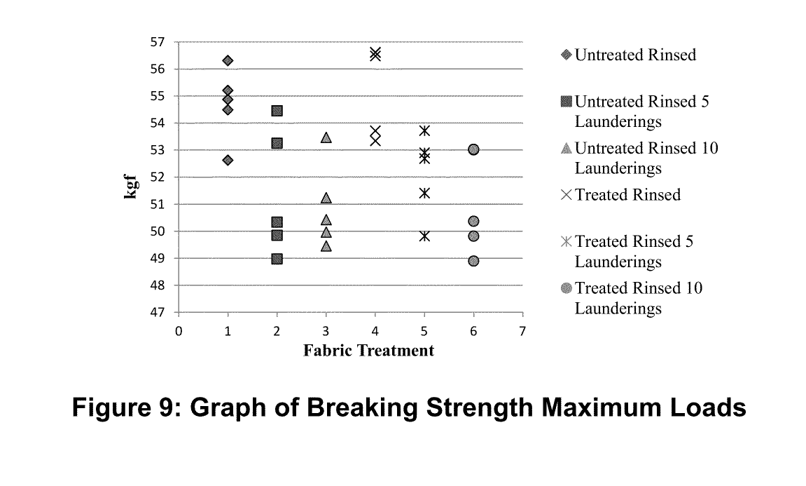

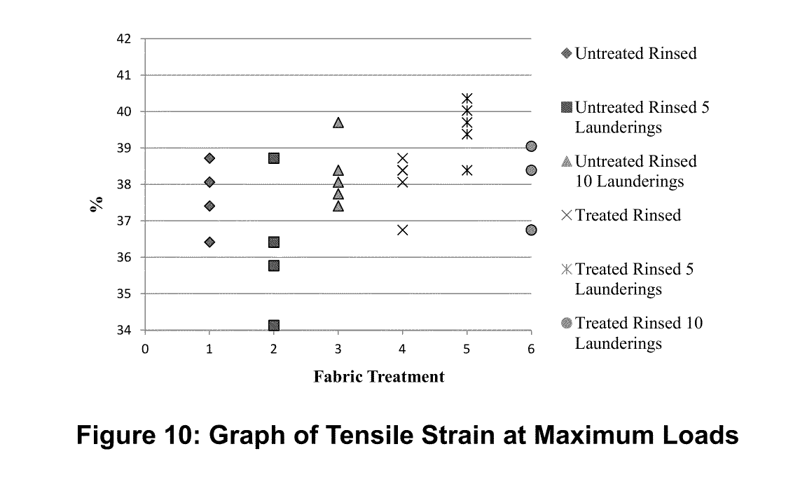

The variation in breaking strength and strain between the samples is minimal, as depicted in Tables 12 and 13 and FIGS. 9 and 10. The only difference larger than two percent between samples was the tensile strain of the untreated rinsed sample that was laundered five times and the treated sample that was rinsed and laundered five times. The sample that was treated and rinsed and put through five laundering cycles had 8.3 percent greater tensile strain at the maximum load. Overall the treated samples exhibited the ability to withstand a larger maximum load. Based on two tailed t-tests, as shown in Tables 14, 15, and 16, the only significant difference is between the untreated sample that had been rinsed and laundered five times, and its treated counterpart. It is possible that the variation in breaking strength and strain at the maximum load is related to the inherent variation between the lab coats rather than being influenced by the antimicrobial treatment.

All of the untreated samples as well as the treated samples (rinsed and laundered), upon visual inspection, appeared to be minimally affected by abrasion. Broken fibers created a slightly “fuzzier” surface on the face on all abraded samples, but variation in the state of the samples between the cycles (2,500, 5,000, 7,500, and 10,000) was undetectable, as was variation between the untreated and treated samples. Based on this abrasion test, the antimicrobial treatment has no negative effect on the lab coats. The fabric-to-fabric abrasion that would occur during daily wear would be no more noticeable on the treated lab coats than it would be on an untreated lab coat.

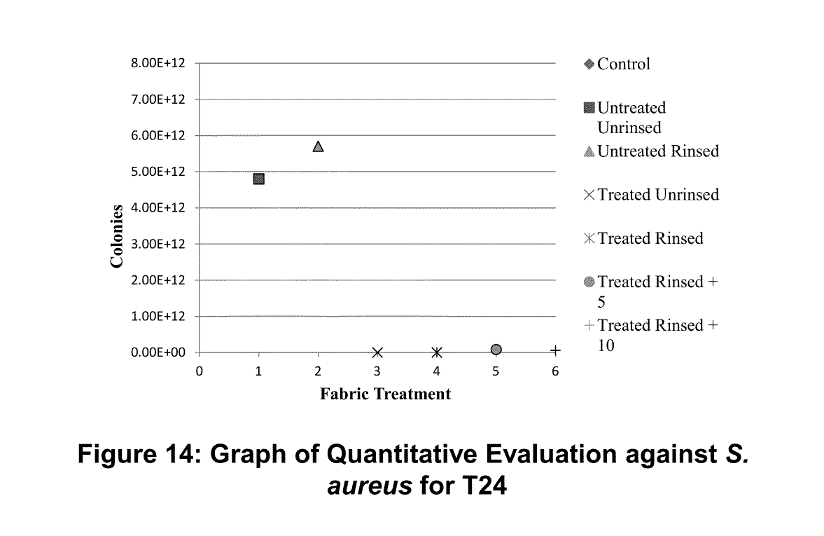

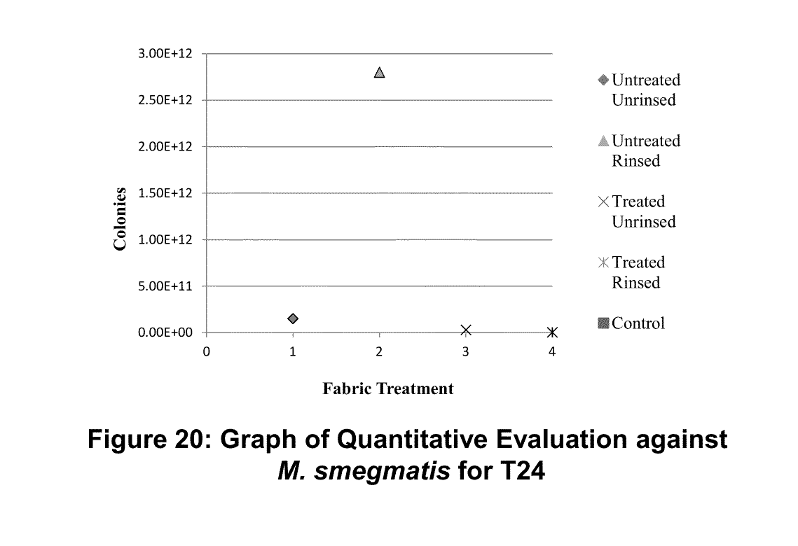

The antimicrobial treatment is extremely effective against S. aureus, B. cereus, and M. smegmatis. The qualitative antimicrobial assessment (AATCC 147) for all treated samples exhibited a three to six millimeter zone of inhibition when visually evaluated. The data gathered by the qualitative evaluation against S. aureus for each sample is depicted in Table 17. All treated samples (treated, unrinsed; treated, rinsed; treated, rinsed, laundered five times; and treated, rinsed, laundered ten times) were evaluated against S. aureus. Tables 19 and 21 depict the data gathered for the qualitative evaluations against B. cereus and M. smegmatis, respectively. Only the treated unrinsed and treated rinsed samples were tested. The quantitative data (AATCC 100) for all test organisms verified that the antimicrobial treatment is 99.99 percent effective with four and five log reductions of each test organism. The efficacy of the antimicrobial treatment remains remarkably effective up to ten laundering cycles with a 99.99 percent reduction of the S. aureus test organism as can be seen in table eighteen. Tables 19 and 21 depict the qualitative evaluation of the coats against different microorganisms. It is clearly evident that the treated coats are much more effective in limiting growth of microorganisms than the untreated coats. Although there appears to be a difference between the treated unrinsed and treated rinsed coats, this difference is minor. Due to time constraints, only the treated unrinsed and treated rinsed samples were evaluated quantitatively against B. cereus and M. smegmatis. Tables 20 and 22 depict the results gathered from the quantitative evaluations against B. cereus and M. smegmatis, respectively. FIGS. 14 and 20 have no control depicted on the graph due to it lying outside the reasonable limits that were able to be depicted graphically.

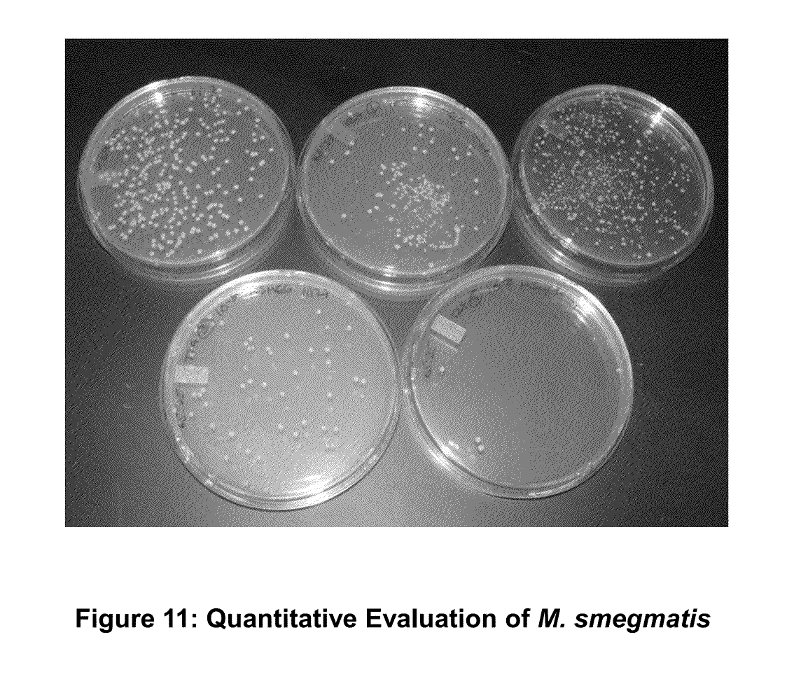

FIG. 11 depicts the quantitative evaluation of M. smegmatis. The top left plate is the control growth after twenty four hours at a 10⁻¹² dilution of the growth medium. The top middle plate is the untreated unrinsed sample, and the top right is the untreated rinsed sample. The left plate in the bottom row is the treated unrinsed sample and the right plate in the bottom row is the treated and rinsed sample. (The quantitative data is obtained using a 10⁻⁸ dilution of the nutrient broth i.e. 4 logs lower than the control.)

The Kawabata Evaluation System bending measurement analyzes the resistance to bending (‘B’), a factor influencing ease of movement and comfort of a garment, and the recovery from bending (‘2HB’), which influences the appearance retention of a garment. The lower the value for ‘B’, the greater the ease of movement and thus comfort of the garment. The lower the value for ‘2HB’, the better the recovery from bending of the fabric and therefore the better the appearance retention. A difference of less than ten percent is often considered to be non-significant. Table 23 displays the data gathered from the bending evaluation. The ‘B’ values for the treated samples (rinsed, rinsed and laundered five times, and rinsed and laundered ten times) are a significant percentage (significant being greater than ten percent) lower than their untreated counterparts, 12.4 percent, 14.5 percent, and 11.6 percent, respectively. The samples with the antimicrobial treatment also achieved better results in the recovery portion of the test with the rinsed, rinsed that had been laundered five times, and rinsed that had been laundered ten times, 22.6 percent, 5.6 percent and 10.4 percent, respectively, lower than the untreated samples. The results indicate that the antimicrobial treatment has no negative impact on the lab coats.

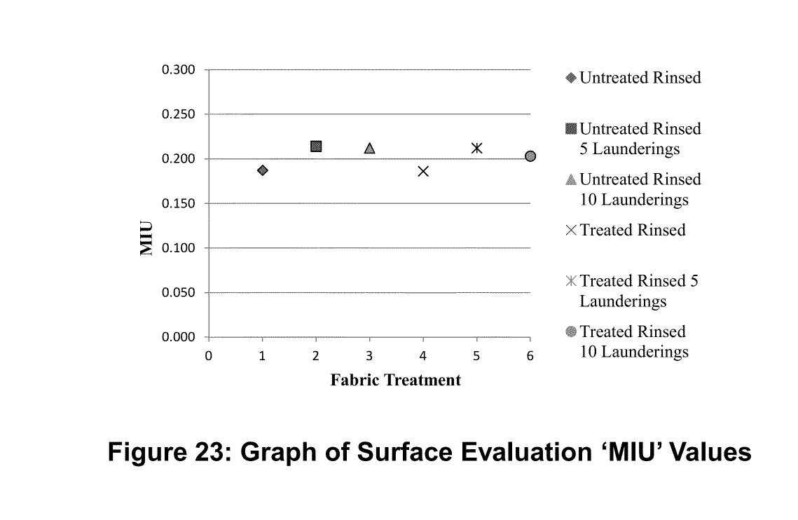

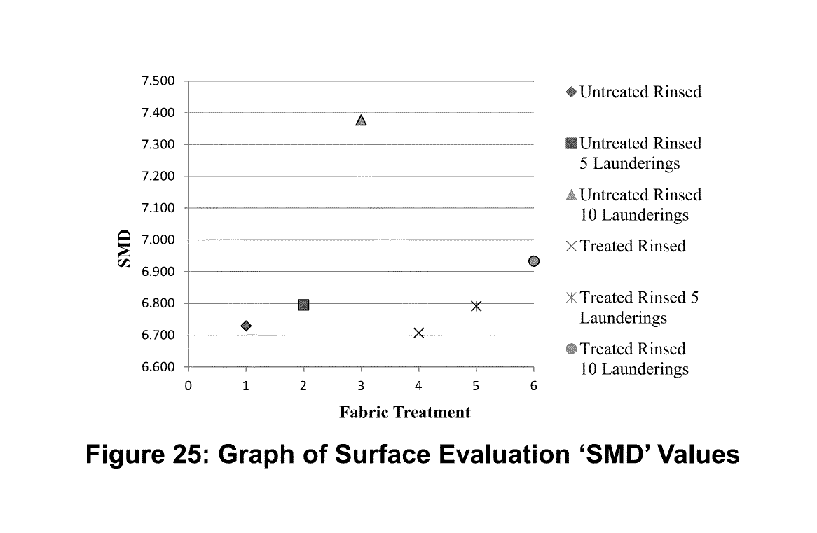

The Kawabata Evaluation System surface test measures the surface friction (MIU), the mean deviation of the surface friction (MMD), and the surface roughness (SMD). The treated samples had lower values for the MIU and SMD evaluations, but the percent differences were not significant (significant being ten percent and higher). The MIU and SMD data can be seen graphically in FIGS. 23 and 25, respectively. The largest difference was found in the surface roughness (SMD) which had a six percent difference between the untreated sample that was rinsed and laundered ten times and its treated counterpart.

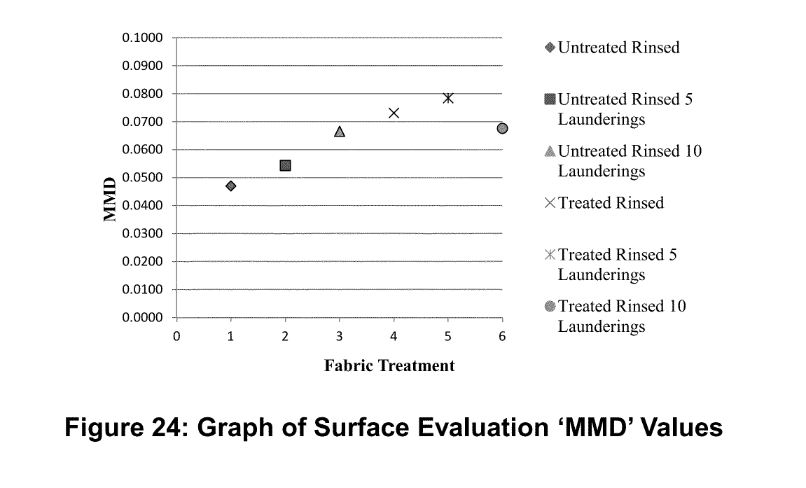

Small differences in the mean deviation of the coefficient of friction (MMD) can sometimes be perceived by individuals, even though there is only a slight difference in the surface friction between materials. The MMD values are significantly higher in the treated samples that were rinsed, and the treated samples that were rinsed and laundered five times having 35.7 percent and 30.7 percent greater values respectively, than their untreated counter parts, as can be seen in Table 24 as well as graphically in FIG. 24. After the treated and rinsed samples were laundered ten times the difference compared to the untreated rinsed and ten launderings is much less significant at 1.6 percent with the treated samples still having the greater MMD values. The data suggests that an individual would be able to recognize a difference in the smoothness of the untreated lab coats versus the treated lab coats, perceiving the untreated lab coats as smoother. However the only way to confirm this would be to have human subjects handle the coats and evaluate them. It is possible that, although the percent difference seems significant, the sensitivity could be minimal and the added benefit of the antimicrobial treatment would outweigh any alleged lack of smoothness. Lab coats are worn over regular apparel, so it is possible that users may not notice much of a difference in actual use.

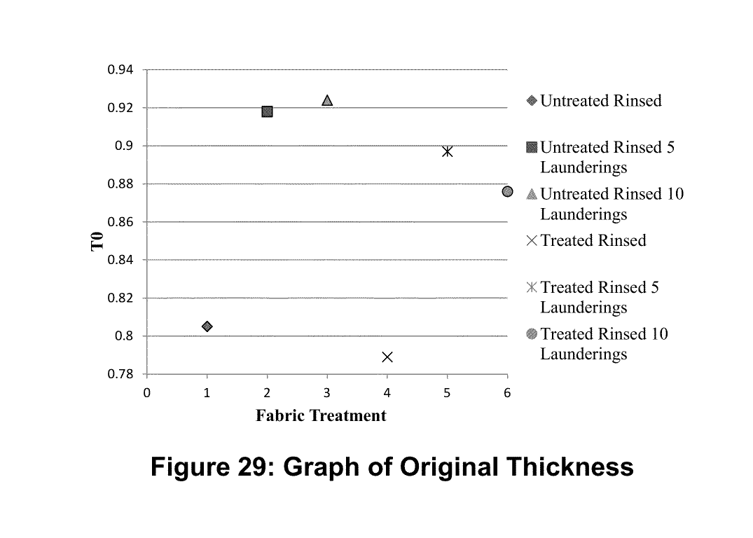

Compliance of compression (LC), which corresponds to perception of comfort, the work of compression (WC), the compression energy, the recovery from compression (RC), the fabric's ability to regain thickness after the force is removed, as well as the original fabric thickness under 0.5 g/cm² (T0) and the fabric thickness under the maximum compression of 50 g/cm² (TM) are evaluated in the compression test of the Kawabata Evaluation System. There is a slight difference in the original fabric thickness (T0) of the untreated samples compared to the treated samples. The differences can be seen graphically in FIG. 29. The untreated rinsed and untreated rinsed with five launderings samples were two percent thicker than their treated counterparts. The untreated rinsed sample that had been through ten laundering cycles was approximately five percent thicker than the treated rinsed sample that had been through the same number of launderings. The variation in the original thickness can be associated with the antimicrobial treatment process. A similar trend was noticed for the thickness under maximum pressure (TM), however the percent difference is lower, with a difference of 1.6, 0.4, and 2 percent for the rinsed; rinsed with five launderings; and rinsed with ten laundering samples respectively; the untreated samples being thicker than the treated.

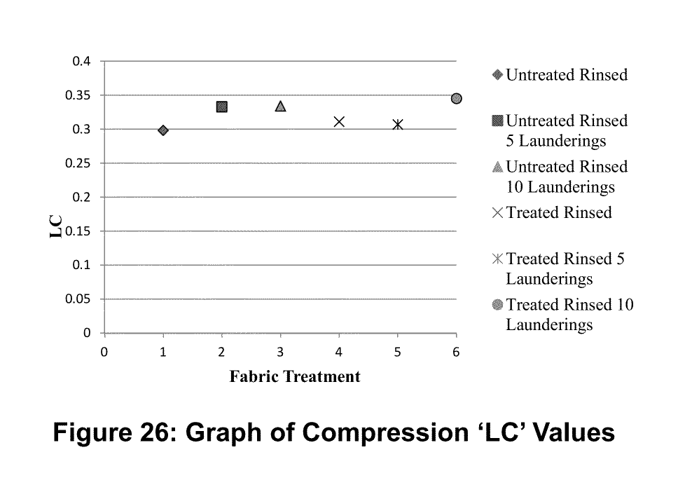

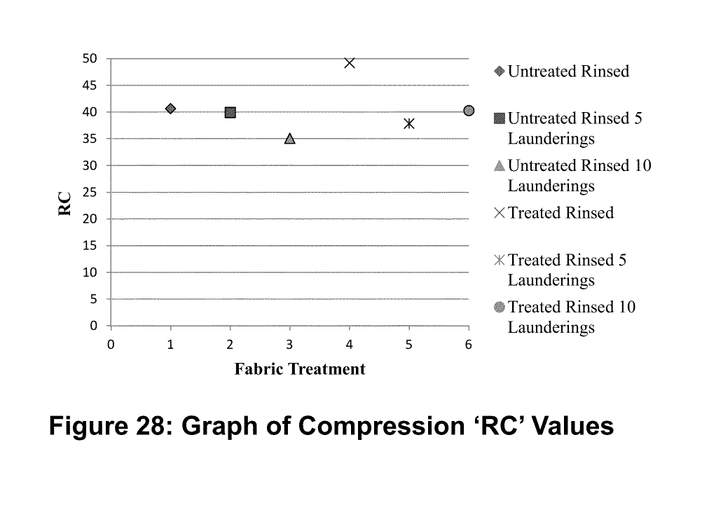

Graphical representation of the compliance of pressure values can be seen in FIG. 26. The treated samples that were rinsed and rinsed with ten launderings had higher values for compliance of pressure (LC), however with differences of four percent and three percent, respectively, to the untreated counterparts, it is not a significant difference (significant being greater than ten percent). The treated sample that had been rinsed and laundered five times performed slightly better in the LC category with a 7.8 percent lower value than its untreated equivalent. A lower value for the compliance of pressure (LC) indicates compliance with pressure which corresponds to the perception of comfort. The recovery from compression (RC) values are greater for the treated, rinsed; and treated, rinsed, and laundered ten times samples, as compared to their untreated counterparts with 17.4 and 13 percent greater values respectively. Higher values for recovery from compression indicate improved appearance retention. The treated sample that had been rinsed and laundered five times exhibited an approximately 5 percent lower value compared to its untreated counterpart in the RC category. The recovery from compression values can be seen graphically in FIG. 28. The untreated rinsed samples that were laundered five and ten times had greater values in the work of compression evaluation. Higher values for the work of compression (WC) evaluation indicate better compliance. A significantly greater value (12.3 percent) was achieved by the untreated rinsed sample that had undergone five laundering cycles compared to its treated counterpart. Human evaluation is needed to determine if a difference of that magnitude is actually perceivable. From the data collected by the compression testing performed by the Kawabata Evaluation System it can be concluded that the antimicrobial treatment does not have a negative effect on the fabrics.

The Kawabata Evaluation System evaluates shear with the following parameters; ‘G’, which indicates a fabric's resistance to shear, as well as ‘2HG’ and ‘2HG5’, which are both indicative of a fabrics ability to recover from shearing at 0.5 and 5 degrees, respectively. Lower values for each parameter are desirable. A lower value for the resistance to shear indicates less resistance and greater ease of movement, and lower values for recovery from shear at both 0.5 and 5 degrees indicate good appearance retention. The treated samples had lower values for each of the parameters. A significant difference (significant being greater than ten percent) of 10.8 percent was exhibited between the untreated sample that had been rinsed and laundered five times and its treated equivalent for the ‘G’ parameter. The untreated rinsed sample value was 28.4 percent greater than its treated counterpart for the ‘2HG’ parameter, and the untreated, rinsed sample was 12.5 percent greater than the treated and rinsed sample for the ‘2HG5’ parameter. From the data gathered the antimicrobial treatment has no negative impact on the shear properties of the fabric, and may in fact contribute to the fabric's improved shear performance.

The Kawabata Evaluation Systems tensile test evaluates tensile properties based on the fabric's linearity of tension (LT), the work or compliance of the fabric to the tensile force (WT), the work of recovery (RT), and the extension of the fabric at maximum tensile force (EMT). The treated samples exhibited lower values for the linearity of tension parameter compared to the untreated samples for the rinsed; rinsed and laundered five times; and rinsed and laundered ten times, with values 5, 7.4, and 0.75 percent, respectively, lower. The differences are not significant (significant being greater than ten percent), but the data proves that the antimicrobial treatment does not negatively affect the ability of the fabric to yield under tension; therefore it does not take away from the comfort of the lab coat.

There are three instances of significant difference in the tensile properties of the untreated versus treated samples. The value for the compliance (WT) of the treated sample that had been rinsed and laundered ten times is 16.8 percent greater than its untreated counterpart. Greater values for the ‘WT’ parameter indicate better compliance with tensile force. The untreated, rinsed; and untreated, rinsed with five launderings had values slightly higher, 6.5 and 5.2 percent respectively, than their treated counterparts. The second significant difference is found within the evaluation of the fabric ability to recover. The untreated sample that had been rinsed and laundered ten times had a twelve percent greater value than its treated equivalent; however the treated samples had values 8.4 and 0.81 percent greater than the untreated, rinsed; and untreated, rinsed, and laundered five times, respectively. Greater values for the ‘RT’ parameter indicate better fit and comfort.

Finally, the EMT value which indicates the fabric ability for greater extension, which corresponds to improved comfort and ease of movement, was 17.1 percent greater for the treated, rinsed and laundered ten times sample than the untreated sample that was rinsed and laundered ten times. The treated sample that was rinsed and laundered five times also exhibited a greater value than its untreated counterpart, but only by three percent. The untreated, rinsed sample had a value that was slightly greater, 1.6 percent, than the treated rinsed sample. Overall the antimicrobial treatment had no adverse effect on the tensile properties of the lab coats. Thus the fit and comfort of the treated lab coats would be no different than that of the untreated lab coats.

The naturally derived antimicrobial treatment demonstrated exceptional results in its antimicrobial efficacy proving to be bacteriocidal against S. aureus, B. cereus, and M. smegmatis, and durable up to ten laundering cycles. Due to the antimicrobial treatment's exceptional results and durability to laundering, it is possible that the treatment could reduce the amount of laundry additives required in the washing of textile products for hospitals and similar institutions. The mechanical property tests indicated that overall the antimicrobial treatment has no adverse effects on the fabric. In some instances it is possible that the antimicrobial treatment contributes to the improved performance and prevention of reduction in some properties after multiple laundering cycles, for example, the deterrence of further reduction in tear strength after multiple launderings. The treated lab coat's performance in the breaking strength test demonstrated larger maximum loads than the untreated samples. It is possible that lab coats treated with the naturally derived antimicrobial could have a longer lifespan than untreated lab coats due to the improved breaking strength and prevention of the decline in tearing strength after multiple laundering cycles. Although it was not a recorded experiment, the handling of the samples treated with the naturally derived antimicrobial did not cause any skin sensitivity or discomfort.

TABLE 24
Kawabata Evaluation System - Surface

| Sample | MIU | MMD | SMD |
|---|---|---|---|
| Untreated Rinsed | 0.187 | 0.0470 | 6.729 |
| Untreated Rinsed with 5 | 0.214 | 0.0543 | 6.795 |
| Laundering Cycles | | | |
| Untreated Rinsed with 10 | 0.212 | 0.0665 | 7.377 |
| Laundering Cycles | | | |
| Treated Rinsed | 0.186 | 0.0731 | 6.707 |
| Treated Rinsed with 5 | 0.212 | 0.0784 | 6.791 |
| Laundering Cycles | | | |
| Treated Rinsed with 10 | 0.203 | 0.0676 | 6.933 |
| Laundering Cycles | | | |

TABLE 17
Qualitative Evaluation against S. aureus

| Sample | Diameter of Inhibition (mm) |
|---|---|
| Untreated Unrinsed | 0 |
| Untreated Rinsed | 1 |
| Treated Unrinsed | 4 |
| Treated Rinsed | 3 |
| Treated Rinsed + 5 Wash | 3 |
| Treated Rinsed + 10 Wash | 3 |

TABLE 19
Qualitative Evaluation against B. cereus

| | Diameter of Inhibition |
|---|---|
| Sample | (mm) |
| Untreated Unrinsed | 1 |
| Untreated Rinsed | 2 |
| Treated Unrinsed | 3 |
| Treated Rinsed | 6 |

TABLE 20
Quantitative Evaluation against B. cereus

| | | | Percent |
|---|---|---|---|
| Sample | T0 | T24 | Reduction from Control |
| Control | 2.3 × 10⁸ | 2.0 × 10¹⁴ | |
| Untreated Unrinsed | 1.7 × 10⁸ | 3.1 × 10¹³ | 85% (1 logs) |
| Untreated Rinsed | 1.5 × 10⁸ | 2.9 × 10¹³ | 85% (1 logs) |
| Treated Unrinsed | 2.0 × 10⁸ | 1.12 × 10¹⁰ | 99.99% (4 logs) |
| Treated Rinsed | 2.1 × 10⁸ | 1.0 × 10⁹ | 99.99% (5 logs) |

TABLE 21
Qualitative Evaluation against M. smegmatis

| | Diameter of Inhibition |
|---|---|
| Sample | (mm) |
| Untreated Unrinsed | 2 |
| Untreated Rinsed | 1 |
| Treated Unrinsed | 3 |
| Treated Rinsed | 5 |

TABLE 22
Quantitative Evaluation against M. smegmatis

| | | | Percent Reduction |
|---|---|---|---|
| Sample | T0 | T24 | from Control |
| Control | 2.5 × 10⁸ | 1.64 × 10¹⁴ | |
| Untreated Unrinsed | 1.9 × 10⁸ | 1.5 × 10¹¹ | 99% (3 logs) |
| Untreated Rinsed | 1.6 × 10⁸ | 2.8 × 10¹² | 83% (2 logs) |
| Treated Unrinsed | 2.1 × 10⁸ | 3.0 × 10¹⁰ | 99.99% (4 logs) |
| Treated Rinsed | 2.3 × 10⁸ | 3.0 × 10⁹ | 99.99% (5 logs) |

TABLE 12
Breaking Strength (Untreated Samples)

| | | Individual | Average | Standard |
|---|---|---|---|---|
| | | Load | Load | Deviation |
| Sample | | (kgf) | (kgf) | (kgf) |
| Untreated | Max. Load | 54.87 | 54.70 | 1.34 |
| Rinsed | (kgf) | 56.32 | | |
| | | 52.63 | | |
| | | 54.59 | | |
| | | 55.21 | | |
| | Tensile Strain at | 36.42 | 37.74 | 0.87 |
| | Max. Load (%) | 38.06 | | |
| | | 37.41 | | |
| | | 38.72 | | |
| | | 38.06 | | |
| Untreated | Max. Load | 49.85 | 51.38 | 2.36 |
| Rinsed with 5 | (kgf) | 53.26 | | |
| Laundering | | 48.98 | | |
| Cycles | | 50.34 | | |
| | | 54.46 | | |
| | Tensile Strain at | 36.42 | 36.29 | 1.65 |
| | Max. Load (%) | 38.72 | | |
| | | 35.77 | | |
| | | 34.13 | | |
| | | 36.42 | | |
| Untreated | Max. Load | 49.46 | 50.91 | 1.57 |
| Rinsed with 10 | (kgf) | 51.24 | | |
| Laundering | | 53.47 | | |
| Cycles | | 49.97 | | |
| | | 50.43 | | |
| | Tensile Strain at | 37.41 | 38.26 | 0.89 |
| | Max. Load (%) | 38.39 | | |
| | | 39.70 | | |
| | | 37.74 | | |
| | | 38.06 | | |

TABLE 13
Breaking Strength (Treated Samples)

| | | Individual | Average | Standard |
|---|---|---|---|---|
| | | Load | Load | Deviation |
| Sample | | (kgf) | (kgf) | (kgf) |
| Treated Rinsed | Max. Load | 53.71 | 55.35 | 1.68 |
| | (kgf) | 53.34 | | |
| | | 56.62 | | |
| | | 56.48 | | |
| | | 56.61 | | |
| | Tensile Strain | 36.75 | 38.06 | 0.77 |
| | at Max. Load | 38.39 | | |
| | (%) | 38.06 | | |
| | | 38.39 | | |
| | | 38.72 | | |
| Treated Rinsed | Max. Load | 51.41 | 52.11 | 1.53 |
| with 5 | (kgf) | 52.69 | | |
| Laundering | | 53.72 | | |
| Cycles | | 52.90 | | |
| | | 49.82 | | |
| | Tensile Strain | 38.39 | 39.57 | 0.76 |
| | at Max. Load | 40.03 | | |
| | (%) | 40.36 | | |
| | | 39.70 | | |
| | | 39.38 | | |
| Treated Rinsed | Max. Load | 48.90 | 51.03 | 1.89 |
| with 10 | (kgf) | 53.01 | | |
| Laundering | | 53.03 | | |
| Cycles | | 50.37 | | |
| | | 49.82 | | |
| | Tensile Strain | 36.75 | 37.54 | 1.10 |
| | at Max. Load | 39.05 | | |
| | (%) | 38.39 | | |
| | | 36.75 | | |
| | | 36.75 | | |

TABLE 14
t-test: Two-Sample Assuming Equal Variances

| | Untreated Rinsed | Treated Rinsed |
|---|---|---|
| Mean | 37.734 | 38.062 |
| Variance | 0.75408 | 0.59237 |
| Observations | 5 | 5 |
| Pooled Variance | 0.673225 | |
| Hypothesized Mean | 0 | |
| Difference | | |
| DF | 8 | |
| t Stat | −0.632067894 | |
| P(T <= t) one-tail | 0.272489017 | |
| t Critical one-tail | 1.859548033 | |
| P(T <= t) two-tail | 0.544978034 | |
| t Critical two-tail | 2.306004133 | |

TABLE 15
t-test: Two-Sample Assuming Equal Variances

| | Untreated Rinsed + 5 Wash | Treated Rinsed + 5 Wash |
|---|---|---|
| Mean | 36.292 | 39.572 |
| Variance | 2.71867 | 0.57027 |
| Observations | 5 | 5 |
| Pooled Variance | 1.64447 | |
| Hypothesized | 0 | |
| Mean | | |
| Difference | | |
| DF | 8 | |
| t Stat | −4.044183663 | |
| P(T <= t) one-tail | 0.001857046 | |
| t Critical one-tail | 1.859548033 | |
| P(T <= t) two-tail | 0.003714092 | |
| t Critical two-tail | 2.306004133 | |

TABLE 16
t-test: Two-Sample Assuming Equal Variances

| | Untreated Rinsed + 10 | Treated Rinsed + 10 |
|---|---|---|
| | Wash | Wash |
| Mean | 38.26 | 37.538 |
| Variance | 0.78085 | 1.21872 |
| Observations | 5 | 5 |
| Pooled Variance | 0.999785 | |
| Hypothesized Mean | 0 | |
| Difference | | |
| DF | 8 | |
| t Stat | 1.141704975 | |
| P(T <= t) one-tail | 0.143298021 | |
| t Critical one-tail | 1.859548033 | |
| P(T <= t) two-tail | 0.286596041 | |
| t Critical two-tail | 2.306004133 | |

TABLE 8
Tearing Strength

| | Individual | Average | Standard |
|---|---|---|---|
| | Load | Load | Deviation |
| Sample | (kgf) | (kgf) | (kgf) |
| Untreated Rinsed | 2.04 | 2.19 | 0.170 |
| | 2.44 | | |
| | 2.26 | | |
| | 2.03 | | |
| | 2.19 | | |
| Untreated Rinsed with | 2.09 | 1.99 | 0.056 |
| 5 Laundering Cycles | 1.98 | | |
| | 1.95 | | |
| | 1.96 | | |
| | 1.96 | | |
| Untreated Rinsed with | 1.75 | 1.76 | 0.054 |
| 10 Laundering Cycles | 1.72 | | |
| | 1.83 | | |
| | 1.80 | | |
| | 1.70 | | |
| Treated Rinsed | 2.00 | 1.95 | 0.053 |
| | 2.01 | | |
| | 1.94 | | |
| | 1.94 | | |
| | 1.88 | | |
| Treated Rinsed with | 2.10 | 2.10 | 0.086 |
| 5 Laundering Cycles | 2.00 | | |
| | 2.21 | | |
| | 2.03 | | |
| | 2.14 | | |
| Treated Rinsed with | 1.78 | 1.81 | 0.051 |
| 10 Laundering Cycles | 1.83 | | |
| | 1.82 | | |
| | 1.74 | | |
| | 1.87 | | |

TABLE 9
t-test: Two-Sample Assuming Equal Variances

| | Untreated Rinsed | Treated Rinsed |
|---|---|---|
| Mean | 2.192 | 1.954 |
| Variance | 0.02887 | 0.00278 |
| Observations | 5 | 5 |
| Pooled Variance | 0.015825 | |
| Hypothesized Mean | 0 | |
| Difference | | |
| DF | 8 | |
| t Stat | 2.99140422 | |
| P(T <= t) one-tail | 0.008648434 | |
| t Critical one-tail | 1.859548033 | |
| P(T <= t) two-tail | 0.017296867 | |
| t Critical two-tail | 2.306004133 | |

TABLE 10
t-test: Two-Sample Assuming Equal Variances

| | Untreated Rinsed + 5 Wash | Treated Rinsed + 5 Wash |
|---|---|---|
| Mean | 1.988 | 2.096 |
| Variance | 0.00337 | 0.00713 |
| Observations | 5 | 5 |
| Pooled Variance | 0.00525 | |
| Hypothesized | 0 | |
| Mean | | |
| Difference | | |
| DF | 8 | |
| t Stat | −2.356753215 | |
| P(T <= t) one-tail | 0.023095869 | |
| t Critical one-tail | 1.859548033 | |
| P(T <= t) two-tail | 0.046191738 | |
| t Critical two-tail | 2.306004133 | |

TABLE 11
t-test: Two-Sample Assuming Equal Variances

| | Untreated Rinsed + 10 | Treated Rinsed + 10 |
|---|---|---|
| | Wash | Wash |
| Mean | 1.76 | 1.808 |
| Variance | 0.00295 | 0.00247 |
| Observations | 5 | 5 |
| Pooled Variance | 0.00271 | |
| Hypothesized Mean | 0 | |
| Difference | | |
| DF | 8 | |
| t Stat | −1.457896174 | |
| P(T <= t) one-tail | 0.091489147 | |
| t Critical one-tail | 1.859548033 | |
| P(T <= t) two-tail | 0.182978295 | |
| t Critical two-tail | 2.306004133 | |

TABLE 1
Synthetic Antimicrobial Toxicity & Interactions

| Biocide | Toxicity | Fiber Interactions/Side Effects |
|---|---|---|
| Triclosan | Breaks down into toxic | Large amount needed; bacterial |
| | dioxin | resistance |
| Halamines | Moderate to highly toxic | Needs regeneration; odor from |
| | | residual chlorine. |
| QACs | Moderate to highly toxic | Covalent bonding; durable; |
| | | possible bacterial resistance. |
| PHMB | Moderate acute aquatic | Large amount needed; potential |
| | toxicity | bacterial resistance. |

The following is claimed:

1) A method for inhibiting the spread of nosocomial infections in institutional health care settings comprising:
a) treating outer garments, worn indoors by employed staff of the institution, to impart antimicrobial properties to those garments by:
i) immersing the garments in a solution of glyxol, eugenol and water;
ii) squeezing the solution out of the garments;
iii) curing the wetted garments under heat; and
iv) drying the cured garments;
b) requiring employed staff to wear the treated garments while working at the institution;
c) laundering the garments after being worn by the staff, for further wear by the staff; and
d) requiring employed staff to wear the treated garments after the garments have been laundered for so long as the garments retain their antimicrobial properties.

2) The method of claim 1 wherein the solution comprises ethanol.

3) The method of claim 1 wherein the solution comprises ethyl acetate.

4) The method of claim 1 wherein individual garments comprise cotton and polyester.

5) The method of claim 1 wherein the garments are made of a fabric that is a blend of cotton and polyester.

6) The method of claim 5 wherein the blend is 75% polyester.

7) The method of claim 5 wherein the blend is 50% polyester.

8) The method of claim 1 wherein the solution comprises about 10 grams of glyxol per liter of solution, and about 1 gram of eugenol per liter of solution.

9) The method of claim 1 wherein ethanol is present in an amount of about 10 percent of the water by volume.

10) The method of claim 1 wherein the ethyl acetate is present in an amount of about 10 percent of the water by volume.

11) The method of claim 1 wherein the solution comprises polyvinyl alcohol.
